(19) United States
(12) Patent Application Publication
(10) Pub. No.: US 2017/0025865 A1
(43) Pub. Date: Jan. 26, 2017

(54) MOLTEN-SALT BATTERY, CHARGE-DISCHARGE METHOD, AND CHARGE-DISCHARGE SYSTEM

(71) Applicant: SUMITOMO ELECTRIC INDUSTRIES, LTD., Osaka-shi (JP)

(72) Inventors: Eiko Imazaki, Osaka-shi (JP); Koji Nitta, Osaka-shi (JP); Shoichiro Sakai, Osaka-shi (JP); Atsushi Fukunaga, Osaka-shi (JP); Koma Numata, Osaka-shi (JP)

(21) Appl. No.: 15/039,460

(22) PCT Filed: Nov. 17, 2014
(86) PCT No.: PCT/JP2014/080350

§ 371 Date: May 26, 2016

(30) Foreign Application Priority Data
Dec. 19, 2013 (JP) 2013-262396

(51) Int. Cl. H02J 7/00; H01M 10/44; H01M 10/48; H01M 4/587; H01M 10/054; H01M 10/39; H01M 4/525; H01M 10/46

(52) U.S. Cl. CPC H02J 7/007; H01M 4/525; H01M 10/443; H01M 10/46; H01M 4/587; H01M 10/054; H01M 10/399; H01M 10/486; H02J 7/0042; H01M 2300/0048

(57) ABSTRACT

A molten-salt battery includes a positive electrode including a positive-electrode active material that reversibly occludes and releases sodium, a negative electrode including a negative-electrode active material that reversibly occludes and releases sodium, a separator disposed between the positive electrode and the negative electrode, and a molten-salt electrolyte. The molten-salt electrolyte contains an ionic liquid in an amount of 90% by mass or more. The ionic liquid contains a first salt and a second salt. The first salt contains a sodium ion which is a first cation, and a first anion. The second salt contains an organic cation which is a second cation, and a second anion. The positive-electrode active material contains a composite oxide having a layered O3-type crystal structure and containing Na, Fe, and Co. An amount of Co relative to a total of Fe and Co contained in the composite oxide is 40 to 60 atomic percent.

### TECHNICAL FIELD

The present invention relates to a molten-salt battery that uses a sodium compound as a positive-electrode active material, a method for charging and discharging a molten-salt battery, and a charge-discharge system that includes a molten-salt battery.

### BACKGROUND ART

In recent years, the demand for nonaqueous electrolyte secondary batteries has been increasing as high-energy density batteries that can store electrical energy. Among nonaqueous electrolyte secondary batteries, lithium ion secondary batteries that use lithium cobalt oxide as a positive-electrode active material have high capacities and high voltages, and practical applications thereof have been developed. However, lithium is expensive.

In view of this, sodium ion secondary batteries that use a sodium compound, which is less expensive and more stable, as a positive-electrode active material have attracted attention. In particular, sodium ion secondary batteries that use sodium chromite as a positive-electrode active material and that use hard carbon as a negative-electrode active material have a voltage of about 3 V on average and high thermal stability, and thus the progress of the development in the future is expected (PTL 1).

However, since sodium chromite has a relatively low capacity, the realization of high-capacity sodium ion secondary batteries is limited as long as sodium chromite is used as a positive-electrode active material. Accordingly, alternative positive-electrode active materials having high capacities have been researched.

It has been reported that NaFe_{y}Co_{1-y}O₂, which has a layered O3-type crystal structure, can exhibit a high capacity in a high potential region and is also good in terms of capacity retention rate (PTL 2).

### CITATION LIST

### Patent Literature

PTL 1: International Publication No. 2011/148864 pamphlet
PTL 2: Japanese Unexamined Patent Application Publication No. 2013-203565

### SUMMARY OF INVENTION

### Technical Problem

In recent years, the development of molten-salt batteries that use flame-retardant molten-salt electrolytes has also been progressing. Molten-salt electrolytes are stable even at a high temperature of, for example, 90° C. or more. However, it is known that, in general, positive-electrode active materials having layered structures become thermally unstable in a charged state.

Furthermore, as in the case of the layer structured positive-electrode active material proposed in PTL 2, when a positive-electrode active material contains Fe and Co, a phenomenon in which Fe and Co dissolve in an electrolyte easily occurs. The dissolution of these transition metals may become a factor of degradation of the positive-electrode active material and shortening of the cycle life.

Therefore, an issue in the field of sodium ion secondary batteries is to realize both a good cycle life and a high capacity in a wide temperature range including a high-temperature range of 90° C. or more.

### Solution to Problem

An aspect of the present invention relates to a molten-salt battery (sodium ion secondary battery) including a positive electrode including a positive-electrode active material that reversibly occludes and releases sodium, a negative electrode including a negative-electrode active material that reversibly occludes and releases sodium, a separator disposed between the positive electrode and the negative electrode, and a molten-salt electrolyte, in which the molten-salt electrolyte contains an ionic liquid in an amount of 90% by mass or more, the ionic liquid contains a first salt and a second salt, the first salt contains a sodium ion which is a first cation, and a first anion, the second salt contains an organic cation which is a second cation, and a second anion, the positive-electrode active material contains a composite oxide having a layered O3-type crystal structure and containing Na, Fe, and Co, and an amount of Co relative to a total of Fe and Co contained in the composite oxide is 40 to 60 atomic percent.

Another aspect of the present invention relates to a charge-discharge method for charging and discharging the molten-salt battery described above, the method including a step of sensing the temperature of the molten-salt battery, a step of charging and discharging the molten-salt battery at an upper limit voltage that is a first voltage V1 when the sensed temperature of the molten-salt battery is a temperature equal to or less than a predetermined temperature T1 selected from a range of 60° C. to 90° C., and a step of charging and discharging the molten-salt battery at an upper limit voltage that is a second voltage V2 lower than the first voltage V1 when the sensed temperature of the molten-salt battery is a temperature exceeding the temperature T1.

Still another aspect of the present invention relates to a charge-discharge system including the molten-salt battery described above, a temperature measurement unit that senses a temperature of the molten-salt battery, a charge control device that controls charging of the molten-salt battery, and a discharge control device that controls discharging of the molten-salt battery, in which the charge control device sets an upper limit voltage of charging to be lower with an increase in the temperature of the molten-salt battery sensed by the temperature measurement unit.

### Advantageous Effects of Invention

According to the present invention, it is possible to obtain a molten-salt battery that realizes both a good cycle life and a high capacity in a wide temperature range including a high-temperature range of, for example, 90° C. or more.

### BRIEF DESCRIPTION OF DRAWINGS

FIG. 1 is a longitudinal sectional view that schematically illustrates a structure of a molten-salt battery according to an embodiment of the present invention.

FIG. 2 is a block diagram illustrating a schematic structure of a charge-discharge system according to an embodiment of the present invention.

FIG. 3 is a graph showing the relationship between the number of cycles and an end-of-charge voltage and between the number of cycles and the discharge capacity of a battery of Example 1 at 40° C.

FIG. 4 is a graph showing the relationship between the number of cycles and an end-of-charge voltage and between the number of cycles and the discharge capacity of a battery of Example 1 at 90° C.

### REFERENCE SIGNS LIST

1: separator, 2: positive electrode, 2a: positive electrode lead strip, 3: negative electrode, 3a: negative electrode lead strip, 7: nut, 8: flange, 9: washer, 10: battery case, 12: container body, 13: lid, 15: external negative electrode terminal, 16: safety valve, 100: charge-discharge system, 101: molten-salt battery, 102: charge-discharge control unit, 103: load apparatus, 105: temperature control device

### Description of Embodiments

### Description of Embodiments of Invention

First, the contents of embodiments of the invention will be listed and described.

An embodiment of the present invention relates to a molten-salt battery including a positive electrode including a positive-electrode active material that reversibly occludes and releases sodium, a negative electrode including a negative-electrode active material that reversibly occludes and releases sodium, a separator disposed between the positive electrode and the negative electrode, and a molten-salt electrolyte. In this molten-salt battery, the molten-salt electrolyte contains an ionic liquid in an amount of 90% by mass or more. The ionic liquid contains a first salt and a second salt. The first salt contains a sodium ion which is a first cation, and a first anion. The second salt contains an organic cation which is a second cation, and a second anion. The positive-electrode active material contains a composite oxide having a layered O3-type crystal structure and containing Na, Fe, and Co. An amount of Co relative to a total of Fe and Co contained in this composite oxide is 40 to 60 atomic percent.

As described above, by combining a positive-electrode active material having a layered O3-type crystal structure and containing Fe and Co with a molten-salt electrolyte containing an ionic liquid, both a good cycle life and a high capacity can be realized in a wide temperature range including a high-temperature range of 90° C. or more. This is because the molten-salt electrolyte is stable even at a high temperature, and in addition, the positive-electrode active material having a layered O3-type crystal structure and containing Fe and Co is less likely to decompose even when charging and discharging are repeated at a high temperature and thus is thermally stable. Furthermore, the dissolution of Fe and Co from the positive-electrode active material is also suppressed by using the molten-salt electrolyte.

The composite oxide having a layered O3-type crystal structure and containing Na, Fe, and Co is represented by, for example, NaₓFe_{y}Co_{z}O₂ (where 0.6≦x≦1, 0.45≦y≦0.55, 0.45≦z≦0.55, and y+z=1). This composite oxide is thermally more stable and easily achieves a high capacity.

Preferably, the first anion and the second anion are each independently represented by a general formula: [(R¹SO₂)(R²SO₂)]N⁻ (where R¹ and R² are each independently F or CₙF₂ₙ₊₁ where 1≦n≦5). In this case, heat resistance and ionic conductivity of the molten-salt electrolyte are further improved.

The second cation that forms the second salt is an organic cation. In this case, it becomes possible to use the molten-salt battery in a wide temperature range, for example, from −20° C. to a high-temperature range of more than 90° C. The effect of suppressing the dissolution of Fe and Co from the positive-electrode active material also increases.

The organic cation is preferably at least one selected from the group consisting of a quaternary ammonium cation and an organic cation having a nitrogen-containing heterocycle. In this case, the melting point of the molten-salt electrolyte can be further lowered, and heat resistance and ionic conductivity of the molten-salt electrolyte are also further improved. The dissolution of transition metals from the positive-electrode active material is more easily suppressed.

The negative-electrode active material is preferably at least one selected from the group consisting of hard carbon, a sodium-containing titanium oxide, and a lithium-containing titanium oxide. In this case, a molten-salt battery having better reversibility of charging and discharging and better thermal stability is obtained.

Another embodiment of the present invention relates to a method for charging and discharging the molten-salt battery. In the above described molten-salt battery, at a high temperature exceeding 90° C., with an increase in the upper limit voltage during charging, the coulombic efficiency of the molten-salt battery tends to decrease. In a high-temperature range, with an increase in the upper limit voltage during charging, the dissolution of transition metals from the positive-electrode active material tends to easily occur. Accordingly, a charge-discharge method according to the present embodiment includes a step of sensing a temperature of the molten-salt battery, a step of charging and discharging the molten-salt battery at an upper limit voltage (end-of-charge voltage) that is a first voltage V1 when the sensed temperature of the molten-salt battery is a temperature equal to or less than a predetermined temperature T1, and a step of charging and discharging the molten-salt battery at an upper limit voltage (end-of-charge voltage) that is a second voltage V2 lower than the first voltage V1 when the sensed temperature of the molten-salt battery is a temperature exceeding the temperature T1. The predetermined temperature T1 is a temperature selected from a range of 60° C. to 90° C. In this case, regardless of the temperature of the molten-salt battery, the cycle life of the molten-salt battery can be further extended. The upper limit temperature at which charging and discharging of the molten-salt battery can be performed is at least 100° C., and 120° C. when a molten salt having particularly high heat resistance is used, though the upper limit temperature depends on the type of molten salt.

Still another embodiment of the present invention relates to a charge-discharge system including the molten-salt battery, a temperature measurement unit that senses a temperature of the molten-salt battery, a charge control device that controls charging of the molten-salt battery, and a discharge control device that controls discharging of the molten-salt battery. The charge control device sets an upper limit voltage of charging to be lower with an increase in the temperature of the molten-salt battery sensed by the temperature measurement unit. With this structure, an appropriate upper limit voltage is selected in accordance with the temperature of the molten-salt battery, and charging can be performed.

The upper limit voltage is selected from, for example, at least two values of a set upper limit voltage Vk (k=1, 2, . . . ) in accordance with the temperature of the molten-salt battery. In this manner, by changing the upper limit voltage stepwise in accordance with the temperature, frequent changes in the upper limit voltage can be avoided, and thus efficient charging and discharging can be performed. In addition, the structure of the charge control device can be simplified.

The first voltage V1 is preferably 3.9 to 4.2 V, and the second voltage V2 is preferably 3.8 V or less. In this case, regardless of the temperature of the molten-salt battery, a higher coulombic efficiency can be maintained, and degradation of the positive-electrode active material due to the dissolution of transition metals is further suppressed. Consequently, cycle characteristics are further improved.

Still another embodiment of the present invention relates to a method for producing a molten-salt battery, the method including a step of obtaining a positive electrode including a positive-electrode active material that reversibly occludes and releases sodium, the positive-electrode active material containing a composite oxide having a layered O3-type crystal structure and containing Na, Fe, and Co, an amount of Co relative to a total of Fe and Co contained in the composite oxide being 40 to 60 atomic percent, an amount of Na relative to a total of metal elements other than Na contained in the composite oxide being 60 to 70 atomic percent; a step of obtaining a negative electrode including a negative-electrode active material that reversibly occludes and releases sodium, the negative-electrode active material being at least one selected from the group consisting of hard carbon, a sodium-containing titanium oxide, and a lithium-containing titanium oxide; and a step of preparing a molten-salt electrolyte that contains an ionic liquid in an amount of 90% by mass or more, the ionic liquid containing a first salt and a second salt, the first salt containing a sodium ion which is a first cation, and a first anion, and the second salt containing an organic cation which is a second cation, and a second anion; a step of bringing the positive electrode and the negative electrode into contact with the molten-salt electrolyte; a step of pre-doping the negative-electrode active material in the negative electrode with sodium; and a step of moving part of sodium pre-doped in the negative-electrode active material to the positive-electrode active material in the positive electrode.

According to the above production method, the amount of sodium which the positive-electrode active material can charge and discharge can be increased. Consequently, a molten-salt battery having a higher capacity is obtained.

In the production method, part of sodium pre-doped in the negative-electrode active material is preferably moved to the positive-electrode active material in the positive electrode until the amount of Na relative to a total of metal elements other than Na becomes 90 to 110 atomic percent. In this case, a molten-salt battery having a higher capacity is obtained.

When sodium is moved to the positive-electrode active material in the positive electrode until the amount of Na relative to the total of metal elements other than Na becomes 90 to 110 atomic percent, preferably 95 to 100 atomic percent, the negative-electrode active material in the negative electrode is preferably doped with sodium in an amount equal to or more than an amount corresponding to an irreversible capacity of the negative-electrode active material. In this case, a molten-salt battery having a higher capacity is obtained.

### Details of Embodiments of Invention

Specific examples of embodiments of the present invention will be described below. The present invention is not limited to these examples but is defined by the claims described below. It is intended that the present invention includes equivalents of the claims and all modifications within the scope of the claims.

### [Positive Electrode]

A positive electrode includes, as a positive-electrode active material, a composite oxide described below. This oxide has a layered structure including MeO₂ layers formed by a transition metal (Me) and oxygen. Sodium reversibly intercalates and deintercalates between the layers. The capacity of this material is higher than that of sodium chromite.

### [Positive-Electrode Active Material]

The positive-electrode active material is a composite oxide having a layered O3-type crystal structure and containing Na, Fe, and Co. In the layered O3-type crystal structure, three types of MeO₂ layers having oxygen arrangements different from each other are stacked in a regular order. Sodium occupies the octahedral site between these layers. Sodium compounds having the layered O3-type crystal structure have the same crystal structures as LiCoO₂, NaCoO₂, NaFeO₂, and the like.

The composite oxide contains Na, Fe, and Co as essential elements. However, a third element other than Na may occupy some of sodium sites. Examples of the third element that can occupy the sodium sites include transition metal elements such as Fe, Co, Ti, Ni, Mn, and Cr; main-group elements such as Al; and alkali metals such as Li and K. However, from the viewpoint of performing stable charging and discharging, the ratio of the third element that occupies the sodium sites is preferably 0.1 atomic percent or less relative to the total of sodium and the third element.

Similarly, a third element other than Fe and Co may occupy some of transition metal sites. Examples of the third element that can occupy the transition metal sites include alkali metals such as Na, K, and Li; transition metal elements such as Ti, Ni, Mn, and Cr; and main-group elements such as Al. However, from the viewpoint of maintaining a stable crystal structure, the ratio of the third element that occupies the transition metal sites is preferably 0.1 atomic percent or less relative to the total of Fe, Co, and the third element.

The amount of Co relative to the total of Fe and Co contained in the composite oxide is 40 to 60 atomic percent, preferably 45 to 55 atomic percent, and particularly preferably 48 to 52 atomic percent. That is, from the viewpoint of stabilizing the crystal structure, Fe and Co are preferably contained in the composite oxide so that the proportion of Fe and the proportion of Co are substantially the same.

More specifically, the composite oxide has a composition represented by, for example, NaₓFe_{y}Co_{z}O₂ (where 0.6≦x≦1, 0.45≦y≦0.55, 0.45≦z≦0.55, and y+z=1). However, the value of x in an initial state immediately after the synthesis of the composite oxide is preferably 0.6 to 0.7. In this case, a composite oxide having a layered O3-type crystal structure is easily obtained at a high yield. The value of x varies as a result of pre-doping with sodium or charging and discharging. The lower limit of x during charging is, for example, 0.25 to 0.35. The upper limit of x during discharging is, for example, 0.85 to 1.1. That is, the composite oxide can occlude sodium in a larger amount than that in the initial state.

A typical example of the composition in the initial state immediately after the synthesis of the composite oxide is NaₓFe_{1/2}Co_{1/2}O₂ where x=⅔, y=½, and z=½. The coefficient of Na may vary from ⅔ by, for example, about 3% in each of the upper and lower ranges. Similarly, the coefficients of Fe and Co may vary from ½ by about 3% in each of the upper and lower ranges.

Since the composite oxide contains Fe and Co, the dissolution of Fe and Co in an organic electrolyte solution containing an organic solvent easily occurs. Herein, the term “organic electrolyte solution” refers to an electrolyte solution in which a sodium salt is dissolved in an organic solvent such as a carbonic acid ester. A typical organic electrolyte solution contains an organic solvent in an amount of, for example, 60% by mass or more.

In contrast, although the composite oxide contains Fe and Co, the dissolution in a molten-salt electrolyte is less likely to occur. Among molten-salt electrolytes, in particular, in an ionic liquid containing an organic cation, the dissolution of Fe and Co tends to be less likely to occur. Although the reason for this is not clear, it is believed that, for example, the concentration of ions contained in the electrolyte, and stability of transition metals in the electrolyte, the transition metals being subjected to solvation, are relevant.

The composite oxide having a layered O3-type crystal structure and containing Na, Fe, and Co can be produced by mixing an Fe compound, a Co compound, and a Na compound, and firing the resulting mixture. Alternatively, a precursor containing Fe and Co and a Na compound may be mixed. The precursor can be obtained, for example, as a coprecipitated hydroxide containing Fe and Co by adding an alkali to a raw material salt solution containing an Fe compound (e.g., iron sulfate) and a Co compound (e.g., cobalt sulfate) in a predetermined concentration ratio. As the Na compound, sodium peroxide, sodium oxide, sodium hydroxide, or the like may be used.

The element ratio in the mixture before firing is adjusted such that the amount of Co relative to the total of Fe and Co becomes 40 to 60 atomic percent. Furthermore, the element ratio is adjusted such that the amount of Na relative to the total of metal elements other than Na becomes 60 to 70 atomic percent. In this case, the layered O3-type composite oxide can be obtained at a high yield.

The positive-electrode active material may contain a third active material other than the composite oxide. Examples of the third active material include sodium chromite (NaCrO₂), Na₂FePO₄F, NaVPO₄F, NaCoPO₄, NaNiPO₄, NaMnPO₄, NaMn_{1.5}Ni_{0.5}O₄, and NaMn_{0.5}Ni_{0.5}O₂. However, from the viewpoint of realizing both a high capacity and a good cycle life, the composite oxide preferably occupies 90% by mass or more of the positive-electrode active material.

The positive-electrode active material preferably has an average particle size of 2 μm or more and 20 μm or less. When the average particle size is in this range, a homogeneous positive-electrode active material layer is easily formed, and electrode reaction also proceeds easily and smoothly. The average particle size (a particle size at a cumulative volume of 50% in the volume particle size distribution) is a median size in the volume particle size distribution obtained by using a laser diffraction particle size analyzer.

The positive electrode includes, for example, a positive electrode current collector, and a positive-electrode active material layer adhering to the positive electrode current collector. The positive-electrode active material layer contains a positive-electrode active material as an essential component and may contain a conductive material, a binder, and the like as optional components.

Examples of the conductive material incorporated in the positive electrode include graphite, carbon black, and carbon fibers. Among the conductive materials, for example, carbon black is preferable from the viewpoint that a sufficient conductive path is easily formed by use of a small amount. The amount of the conductive material is preferably 2 to 15 parts by mass, and more preferably 3 to 8 parts by mass per 100 parts by mass of the positive-electrode active material.

The binder has a function of binding positive-electrode active material particles together and fixing the positive-electrode active material to the positive electrode current collector. Examples of the binder that can be used include fluororesins, polyamides, polyimides, and polyamide-imides. Examples of the fluororesins that can be used include polyvinylidene fluoride (PVdF), polytetrafluoroethylene (PTFE), tetrafluoroethylene-hexafluoropropylene copolymers, and vinylidene fluoride-hexafluoropropylene copolymers. The amount of the binder is preferably 1 to 10 parts by mass, and more preferably 3 to 5 parts by mass per 100 parts by mass of the positive-electrode active material.

As the positive electrode current collector, a metal foil, a non-woven fabric made of metal fibers, a porous metal sheet, or the like is used. The metal constituting the positive electrode current collector is not particularly limited, but is preferably aluminum or an aluminum alloy because aluminum and aluminum alloys are stable at the positive electrode potential. When an aluminum alloy is used, the content of metal components (for example, Fe, Si, Ni, Mn, etc.) other than aluminum is preferably 0.5% by mass or less. The metal foil serving as the positive electrode current collector has a thickness of, for example, 10 to 50 μm. The non-woven fabric made of metal fibers or the porous metal sheet serving as the positive electrode current collector has a thickness of, for example, 100 to 600 μm.

### [Negative Electrode]

The negative electrode includes, as a negative-electrode active material, for example, at least one selected from the group consisting of hard carbon, a sodium-containing titanium oxide, and a lithium-containing titanium oxide. Since these materials reversibly occlude and release sodium, a molten-salt battery having good reversibility of charging and discharging is obtained.

### [Hard Carbon]

Unlike graphite, which has a graphite crystal structure in which carbon layer planes are stacked in layers, hard carbon has a turbostratic structure in which carbon layer planes are stacked in a state of being three-dimensionally displaced. The heat treatment of hard carbon even at a high temperature (e.g., 3,000° C.) does not result in a transformation from the turbostratic structure to the graphitic structure or the development of graphite crystallites. Therefore, hard carbon is also referred to as non-graphitizable carbon.

The average interplanar spacing d₀₀₂ of the (002) planes of a carbonaceous material measured from an X-ray diffraction (XRD) spectrum is used as an index of the degree of development of a graphite crystal structure of the carbonaceous material. The carbonaceous material categorized into graphite typically has a small average interplanar spacing d₀₀₂ less than 0.337 nm. In contrast, the hard carbon with the turbostratic structure has a large average interplanar spacing d₀₀₂ of, for example, 0.37 nm or more, and preferably 0.38 nm or more. The upper limit of the average interplanar spacing d₀₀₂ of the hard carbon is not particularly limited. The average interplanar spacing d₀₀₂ may be, for example, 0.42 nm or less. The average specific gravity of the hard carbon is, for example, 1.7 g/cm³ or less, and preferably 1.4 to 1.7 g/cm³. The average particle size (a particle size at a cumulative volume of 50% in the volume particle size distribution) of the hard carbon is, for example, 3 to 20 μm, and preferably 5 to 15 μm.

### [Sodium-Containing Titanium Oxide]

A preferred example of the sodium-containing titanium oxide is sodium titanate having a spinel structure. More specifically, at least one selected from the group consisting of Na₂Ti₃O₇ and Na₄Ti₅O₁₂ is preferably used. Some of Ti or Na atoms of sodium titanate may be replaced with a third element, for example, at least one selected from the group consisting of Ni, Co, Mn, Fe, Al, and Cr. The proportion of the third element occupying the Na site is preferably 0.1 atomic percent or less relative to the total of Na and the third element. The proportion of the third element occupying the Ti site is preferably 0.1 atomic percent or less relative to the total of Ti and the third element.

### [Lithium-Containing Titanium Oxide]

A preferred example of the lithium-containing titanium oxide is lithium titanate having a spinel structure. More specifically, at least one selected from the group consisting of Li₂Ti₃O₇ and Li₄Ti₅O₁₂ is preferably used. Some of Ti or Li atoms of lithium titanate may be replaced with a third element, for example, at least one selected from the group consisting of Ni, Co, Mn, Fe, Al, and Cr. The proportion of the third element occupying the Li site is preferably 0.1 atomic percent or less relative to the total of Li and the third element. The proportion of the third element occupying the Ti site is preferably 0.1 atomic percent or less relative to the total of Ti and the third element.

The average particle size (a particle size at a cumulative volume of 50% in the volume particle size distribution) of the sodium-containing titanium oxide and the lithium-containing titanium oxide is, for example, 2 to 20 μm, and preferably 2 to 10 μm.

A metal that forms an alloy with sodium, such as zinc, a zinc alloy, tin, a tin alloy, silicon, a silicon alloy, or the like may be used in the negative-electrode active material layer.

The negative electrode includes, for example, a negative electrode current collector, and a negative-electrode active material layer adhering to the negative electrode current collector. The negative-electrode active material layer contains a negative-electrode active material as an essential component and may contain a conductive material, a binder, and the like as optional components. As the binder and the conductive material that are used in the negative electrode, the materials exemplified as the components of the positive electrode can be used. The amount of the binder is preferably 1 to 10 parts by mass, and more preferably 3 to 5 parts by mass per 100 parts by mass of the negative-electrode active material. The amount of the conductive material is preferably 5 to 15 parts by mass, and more preferably 5 to 10 parts by mass per 100 parts by mass of the negative-electrode active material.

As the negative electrode current collector, a metal foil, a non-woven fabric made of metal fibers, a porous metal sheet, or the like is used. The metal constituting the negative electrode current collector is preferably aluminum, an aluminum alloy, copper, a copper alloy, nickel, a nickel alloy or the like because these metals are stable at the negative electrode potential. For example, aluminum alloys the same as those used in the positive electrode current collector can be used. The metal foil serving as the negative electrode current collector has a thickness of, for example, 10 to 50 μm. The non-woven fabric made of metal fibers or the porous metal sheet serving as the negative electrode current collector has a thickness of, for example, 100 to 600 μm.

### [Molten-Salt Electrolyte]

The molten-salt electrolyte is an electrolyte that contains an ionic liquid (molten salt) as a main component, and contains an ionic liquid in an amount of 90% by mass or more. The term “ionic liquid” has the same meaning as a salt in a molten state (molten salt) and refers to a liquid ionic substance formed by an anion and a cation. The ionic liquid contains a first salt and a second salt. The first salt contains a sodium ion, which is a first cation, and a first anion. The second salt contains an organic cation, which is a second cation, and a second anion. Such a molten-salt electrolyte has high heat resistance and incombustibility. In addition, the effect of suppressing the dissolution of transition metals from the positive-electrode active material is obtained.

The molten-salt electrolyte may contain various additives and organic solvents in an amount that does not significantly impair heat resistance and incombustibility. However, the first salt (sodium salt) and the second salt (salt of an organic cation) preferably occupy 95% to 100% by mass of the ionic liquid.

The first anion forming the first salt is preferably a polyatomic anion. Examples thereof include PF₆⁻, BF₄⁻, ClO₄⁻, and a bis(sulfonyl)amide anion represented by [(R¹SO₂)(R²SO₂)]N⁻ (where R¹ and R² are each independently F or CₙF₂ₙ₊₁ where 1≦n≦5). Among these, the bis(sulfonyl)amide anion is preferable from the viewpoint of heat resistance and ionic conductivity of the molten-salt battery. As the first anion, an anion may be used alone or a plurality of anions may be used. Specifically, the first salt may contain a plurality of sodium salts containing different types of first anions.

The second anion forming the second salt is also preferably a polyatomic anion. Anions the same as those exemplified as the first anion may be used. The first anion and the second anion may be the same or different. As the second anion, an anion may be used alone or a plurality of anions may be used. Specifically, the second salt may contain a plurality of salts of an organic cation, the salts containing different types of second anions. The second anion is also preferably the bis(sulfonyl)amide anion. In particular, the first anion and the second anion are preferably the same bis(sulfonyl)amide anion.

Specific examples of the bis(sulfonyl)amide anions include a bis(fluorosulfonyl)amide anion, (fluorosulfonyl)(perfluoroalkylsulfonyl)amide anions, and bis(perfluoroalkylsulfonyl)amide anions. The number of carbon atoms of the perfluoroalkyl group is, for example, 1 to 5, preferably 1 and 2, and more preferably 1. Among these, a bis(fluorosulfonyl)amide anion (FSA); a bis(trifluoromethylsulfonyl)amide anion (TFSA), a bis(pentafluoroethylsulfonyl)amide anion, a (fluorosulfonyl)(trifluoromethylsulfonyl)amide anion, and the like are preferable.

Specific examples of the first salt include a salt of a sodium ion and FSA (Na.FSA) and a salt of a sodium ion and TFSA (Na.TFSA).

Examples of the organic cation forming the second salt include nitrogen-containing cations, sulfur-containing cations, and phosphorus-containing cations. Among these, nitrogen-containing cations are preferable. Examples of the nitrogen-containing cations include, in addition to cations derived from an aliphatic amine or an alicyclic amine (e.g., quaternary ammonium cations), organic cations having a nitrogen-containing heterocycle.

Examples of the quaternary ammonium cations include tetraalkylammonium cations (in particular, e.g., tetraC₁₋₅alkylammonium cations), such as a tetramethylammonium cation, an ethyltrimethylammonium cation, a hexyltrimethylammonium cation, an ethyltrimethylammonium cation, and a triethylmethylammonium cation (TEMA).

Examples of the skeleton of the organic cations having a nitrogen-containing heterocycle include pyrrolidine, imidazole, pyridine, and piperidine. Nitrogen atoms which are constituent atoms of these skeletons may have, as a substituent, an organic group such as an alkyl group. Examples of the alkyl group include alkyl groups having 1 to 5 carbon atoms, such as a methyl group, an ethyl group, a propyl group, and an isopropyl group. The number of carbon atoms of the alkyl group is more preferably 1 to 4, and particularly preferably 1 to 3.

Among the organic cations having a nitrogen-containing heterocycle, organic cations having a pyrrolidine skeleton are promising as a molten-salt electrolyte because of their particularly high heat resistance and a low manufacturing cost. In the organic cations having a pyrrolidine skeleton, the single nitrogen atom constituting the pyrrolidine ring preferably has two alkyl groups.

Specific examples of the organic cations having a pyrrolidine skeleton include a 1,1-dimethylpyrrolidinium cation, a 1,1-diethylpyrrolidinium cation, a 1-ethyl-1 -methylpyrrolidinium cation, a 1-methyl-1-propylpyrrolidinium cation (Py13), a 1-butyl-1-methylpyrrolidinium cation (Py14), and a 1-ethyl-1-propylpyrrolidinium cation. Among these, in particular, Py13 and Py14 are preferable because of their high electrochemical stability.

Specific examples of the organic cations having an imidazole skeleton include a 1,3-dimethylimidazolium cation, a 1-ethyl-3-methylimidazolium cation (EMI), a 1-methyl-3-propylimidazolium cation, a 1-butyl-3-methylimidazolium cation (BMI), a 1-ethyl-3-propylimidazolium cation, and a 1-butyl-3-ethylimidazolium cation. Among these, EMI and BMI are particularly preferable.

The ratio of the first salt to the total of the first salt and the second salt (i.e., the ratio of sodium ion to the total of sodium ion and organic cation) is preferably 10% by mole or more, 20% by mole or more, or 25% by mole or more, more preferably 30% by mole or more, and particularly preferably 40% by mole or more. The ratio of the first salt to the total of the first salt and the second salt (i.e., the ratio of sodium ion to the total of sodium ion and organic cation) is preferably 65% by mole or less, and particularly preferably 55% by mole or less. Such a molten-salt electrolyte has a relatively low viscosity and is advantageous to achieve a high capacity when charging and discharging are performed at a high rate. A preferred upper limit and a preferred lower limit of the ratio of the first salt may be combined freely to determine a preferred range. For example, a preferred range of the ratio of the first salt to the total of the first salt and the second salt may be 10% to 55% by mole, 20% to 55% by mole, or 25% to 55% by mole.

Specific examples of the second salt include a salt of Py13 and FSA (Py13.FSA), a salt of Py13 and TFSA (Py13.TFSA), a salt of Py14 and FSA (Py14.FSA), a salt of Py14 and TFSA (Py14.TFSA), a salt of BMI and FSA (BMI.FSA), a salt of BMI and TFSA (BMI.TFSA), a salt of EMI and FSA (EMI.FSA), a salt of EMI and TFSA (EMI.TFSA), a salt of TEMA and FSA (TEMA.FSA), a salt of TEMA and TFSA (TEMA.TFSA), a salt of TEA and FSA (TEA.FSA), and a salt of TEA and TFSA (TEA.TFSA).

### [Separator]

A separator may be arranged between the positive electrode and the negative electrode. The material of the separator is selected in consideration of the operating temperature of the battery. From the viewpoint of suppressing side reactions with the molten-salt electrolyte, a glass fiber, a silica-containing polyolefin, a fluororesin, alumina, polyphenylene sulfide (PPS), or the like is preferably used. The thickness of the separator is preferably 10 to 500 μm, and more preferably 20 to 50 μm.

### [Electrode Group]

The molten-salt battery is used in a state in which an electrode group including the positive electrode and the negative electrode, and the molten-salt electrolyte are housed in a battery case. The electrode group is formed by stacking or winding the positive electrode and the negative electrode with a separator disposed therebetween.

### [Molten-Salt Battery]

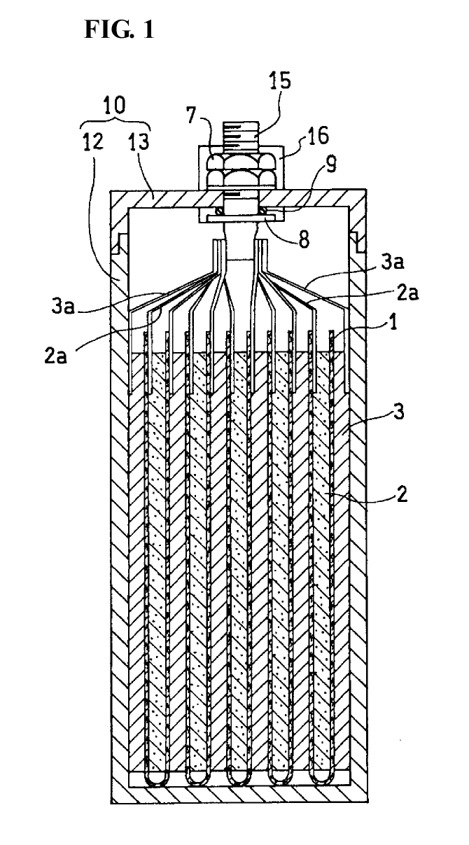

FIG. 1 is a longitudinal sectional view that schematically illustrates a structure of an example of a molten-salt battery. However, the structure of the molten-salt battery according to the present invention is not limited to the structure described below.

A molten-salt battery includes a stack-type electrode group, a molten-salt electrolyte (not shown), and a prismatic aluminum case 10 which houses these components. The case 10 includes a container body 12 having an opening on the top and a closed bottom, and a lid 13 which covers the opening on the top.

When the molten-salt battery is assembled, first, positive electrodes 2 and negative electrodes 3 are stacked with separators 1 provided therebetween to form an electrode group, and the electrode group is inserted into the container body 12 of the case 10. Subsequently, a step of filling gaps between the separators 1, the positive electrodes 2, and the negative electrodes 3 constituting the electrode group with a molten-salt electrolyte is performed by charging a molten-salt electrolyte into the container body 12. Alternatively, the electrode group may be impregnated with the molten-salt electrolyte, and the electrode group containing the electrolyte may then be housed in the container body 12.

A safety valve 16 is provided in the center of the lid 13 for the purpose of releasing gas generated inside when the internal pressure of the case 10 increases. An external positive electrode terminal passing through the lid 13 is provided on one side portion of the lid 13 with respect to the safety valve 16. An external negative electrode terminal 15 passing through the lid 13 is provided on the other side portion of the lid 13.

The stack-type electrode group includes the plurality of positive electrodes 2, the plurality of negative electrodes 3, and the plurality of separators 1 provided therebetween, each of the positive electrodes 2 and the negative electrodes 3 having a rectangular sheet shape. In FIG. 1, each of the separators 1 is formed like a bag so as to enclose the corresponding positive electrode 2. However, the form of each separator is not particularly limited. The plurality of positive electrodes 2 and the plurality of negative electrodes 3 are alternately arranged in the stacking direction in the electrode group.

A positive electrode lead strip 2a may be formed on one end of each of the positive electrodes 2. The positive electrode lead strips 2a of the plurality of positive electrodes 2 are bundled and connected to the external positive electrode terminal provided on the lid 13 of the case 10, so that the positive electrodes 2 are connected in parallel. Similarly, a negative electrode lead strip 3a may be formed on one end of each of the negative electrodes 3. The negative electrode lead strips 3a of the plurality of negative electrodes 3 are bundled and connected to the external negative electrode terminal provided on the lid 13 of the case 10, so that the negative electrodes 3 are connected in parallel. The bundle of the positive electrode lead strips 2a and the bundle of the negative electrode lead strips 3a are preferably arranged on the right and left sides of one end face of the electrode group with a distance between the bundles so as not to be in contact with each other.

Each of the external positive electrode terminal and the external negative electrode terminal is columnar and is provided with a thread groove at least on a portion exposed to the outside. A nut 7 is engaged with the thread groove of each terminal and is screwed to secure the nut 7 to the lid 13. A flange 8 is provided on a portion of each terminal housed in the case 10. The flange 8 is secured to the inner surface of the lid 13 with a washer 9 therebetween by screwing the nut 7.

The electrode group is not limited to the stack-type electrode group. The electrode group may be formed by winding a positive electrode and a negative electrode with a separator disposed therebetween. From the viewpoint of preventing sodium from depositing on the negative electrode, the dimensions of the negative electrode may be larger than those of the positive electrode.

[Pre-Doping with Sodium]

In the positive-electrode active material in the initial state immediately after the synthesis, when the amount of Na relative to the total of metal elements other than Na is 60 to 70 atomic percent, the positive electrode is preferably pre-doped with sodium. When the negative-electrode active material is at least one selected from the group consisting of hard carbon, a sodium-containing titanium oxide, and a lithium-containing titanium oxide, the negative electrode is also preferably doped with sodium. This is because such a negative-electrode active material has an irreversible capacity.

Pre-doping is preferably performed in a state in which the positive electrode and the negative electrode are brought into contact with a molten-salt electrolyte. In order to perform pre-doping efficiently, first, the negative-electrode active material in the negative electrode is pre-doped with sodium. For example, a sodium foil is arranged so as to face the negative electrode, and the negative electrode and the sodium foil are brought into contact with the electrolyte, so that pre-doping of the negative-electrode active material with sodium proceeds.

Next, part of sodium pre-doped in the negative-electrode active material is moved to the positive-electrode active material in the positive electrode. For example, the negative electrode is pre-doped with sodium in advance in an amount exceeding the irreversible capacity, and a discharging reaction is then allowed to proceed, so that part of sodium is moved from the negative electrode to the positive electrode. Consequently, the amount of Na relative to the total of metal elements other than Na can be made larger than the original amount. At this time, the performance of the positive electrode can be exerted at a maximum by pre-doping the positive-electrode active material in the positive electrode with sodium until the amount of Na relative to the total of metal elements other than Na becomes 90 to 110 atomic percent (preferably, 95 to 100 atomic percent).

When the positive-electrode active material is pre-doped with sodium until the amount of Na relative to the total of metal elements other than Na becomes 90 to 110 atomic percent (preferably, 95 to 100 atomic percent), the negative-electrode active material in the negative electrode is preferably doped with sodium in an amount equal to or more than an amount corresponding to the irreversible capacity of the negative-electrode active material. In this case, the amount of sodium involved in charging and discharging can be effectively increased.

### [Charge-Discharge Method]

A method for charging and discharging a molten-salt battery according to an embodiment of the present invention includes a step of sensing a temperature of a molten-salt battery; and a step of switching an upper limit voltage (end-of-charge voltage) of charging in accordance with the sensed temperature of the molten-salt battery.

When the sensed temperature of the molten-salt battery is a temperature equal to or less than a predetermined temperature T1 selected from 60° C. to 90° C. (for example, a temperature of 80° C. or less), the molten-salt battery is charged under the condition in which an upper limit voltage is a first voltage V1. In contrast, when the sensed temperature of the molten-salt battery is a temperature exceeding the temperature T1 (for example, 95° C.), the molten-salt battery is charged under the condition in which the upper limit voltage is a second voltage V2 lower than the first voltage V1. Regarding the charging method, a constant-current charging (CC charging) may be performed, and the charging may be performed in which an upper limit current is determined. Alternatively, after the voltage reaches a predetermined upper limit voltage, a constant-voltage charging (CV charging) may be successively performed until the current converges to a predetermined value.

Herein, the first voltage V1 selected when the temperature is T1 or less is preferably 3.9 to 4.2 V, and more preferably 3.9 to 4.0 V. The second voltage V2 selected when the temperature exceeds T1 is preferably 3.8 V or less, more preferably 3.7 V or less, and particularly preferably 3.5 to 3.7 V. By setting the upper limit voltage in this manner, the coulombic efficiency can be more easily increased. Furthermore, the effect of suppressing the dissolution of transition metals from the positive-electrode active material can also be enhanced. Consequently, the cycle life of the molten-salt battery can be further extended.

Specifically, for example, when the predetermined temperature T1 is 90° C. and the sensed temperature of the molten-salt battery is, for example, 40° C. to 60° C., the molten-salt battery is charged at an upper limit voltage of, for example, 4.0 V or less. When the sensed temperature of the molten-salt battery is, for example, 95° C., the molten-salt battery is charged at an upper limit voltage of, for example, 3.7 V or less.

The temperature of the molten-salt battery may be a temperature of any portion of the molten-salt battery. For example, a temperature of an outer wall surface of the battery case may be measured.

The lower limit voltage in discharging is, for example, 2 to 2.5 V. From the viewpoint of obtaining a high capacity, the lower limit voltage is preferably 2 to 2.2 V.

### [Charge-Discharge System]

The upper limit voltage and the lower limit voltage of charging and discharging of a molten-salt battery are not freely determined by a user or the like, but are characteristics of the molten-salt battery determined at the time of the design in accordance with components of the molten-salt battery. Typically, charging and discharging are respectively controlled by a charge control unit and a discharge control unit included in a charge-discharge system that includes a molten-salt battery. The charge-discharge system may include a temperature control device that controls a temperature of the molten-salt battery. The temperature control device includes, for example, a heater that heats the molten-salt battery, a cooler that cools the molten-salt battery, etc. The charge-discharge system preferably includes a management system that integrally controls the charge control unit, the discharge control unit, the temperature control device, and the like.

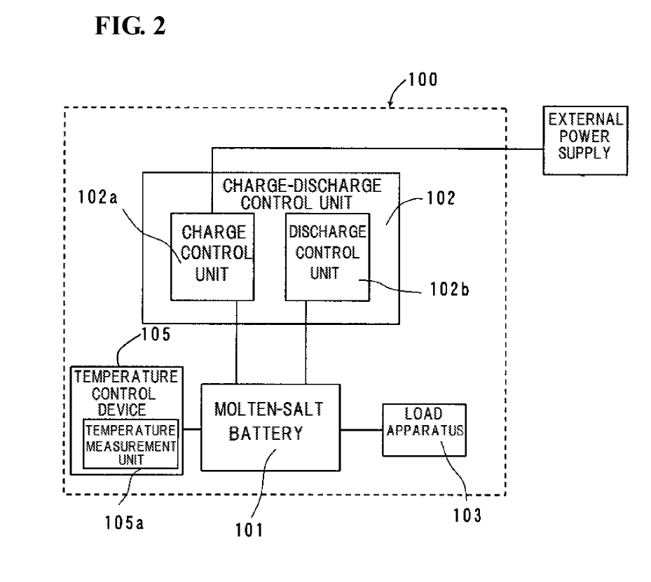

FIG. 2 is a block diagram that schematically illustrates a charge-discharge system according to an embodiment.

A charge-discharge system 100 includes a molten-salt battery 101, a charge-discharge control unit 102 that controls charging and discharging of the molten-salt battery 101, a load apparatus 103 that consumes electric power supplied from the molten-salt battery 101, and a temperature control device 105 that controls a temperature of the molten-salt battery 101. The charge-discharge control unit 102 includes a charge control unit (charge control device) 102a that controls, for example, a current and/or a voltage when the molten-salt battery 101 is charged and a discharge control unit (discharge control device) 102b that controls, for example, a current and/or a voltage when the molten-salt battery 101 is discharged. The temperature control device 105 includes a temperature measurement unit 105a that senses the temperature of the molten-salt battery. The charge control unit 102a sets an upper limit voltage of charging in accordance with the temperature of the molten-salt battery sensed by the temperature measurement unit, and charges the molten-salt battery until the voltage reaches the set upper limit voltage.

The charge control unit 102a includes a memory device (not shown). At least two values of a set upper limit voltage Vk (k=1, 2, . . . ) are memorized in the memory device in advance. The charge control unit 102a selects a set upper limit voltage corresponding to the sensed temperature of the molten-salt battery 101 from the plural values of the set upper limit voltage Vk that have been set in advance. For example, when the temperature of the molten-salt battery 101 is a temperature equal to or less than a predetermined temperature T1 selected in a range of 60° C. to 90° C., the charge control unit 102a selects a first voltage V1 of 3.9 to 4.2 V as the set upper limit voltage Vk. With this structure, in a low-temperature range to a medium-temperature range, deeper charging and discharging can be performed, and the utilization rate of the active material can be increased. In contrast, when the sensed temperature of the molten-salt battery is a temperature exceeding the temperature T1, the charge control unit 102a selects a second voltage V2 of 3.8 V or less as the set upper limit voltage Vk. With this structure, when the temperature of the molten-salt battery is in a high-temperature range, shallower charging is performed. Consequently, even in a high-temperature range, a higher coulombic efficiency is obtained, and the dissolution of transition metals is also less likely to occur.

### [Supplementary Note]

Regarding the embodiments described above, the following appendices are further disclosed.

### (Appendix 1)

A method for producing a molten-salt battery includes

a step of obtaining a positive electrode including a positive-electrode active material that reversibly occludes and releases sodium, the positive-electrode active material containing a composite oxide having a layered O3-type crystal structure and containing Na, Fe, and Co, an amount of Co relative to a total of Fe and Co contained in the composite oxide being 40 to 60 atomic percent, an amount of Na relative to a total of metal elements other than Na contained in the composite oxide being 60 to 70 atomic percent;

a step of obtaining a negative electrode including a negative-electrode active material that reversibly occludes and releases sodium, the negative-electrode active material being at least one selected from the group consisting of hard carbon, a sodium-containing titanium oxide, and a lithium-containing titanium oxide; and

a step of preparing a molten-salt electrolyte that contains an ionic liquid in an amount of 90% by mass or more, the ionic liquid containing a first salt and a second salt, the first salt containing a sodium ion which is a first cation, and a first anion, and the second salt containing an organic cation which is a second cation, and a second anion;

a step of bringing the positive electrode and the negative electrode into contact with the molten-salt electrolyte;

a step of pre-doping the negative-electrode active material in the negative electrode with sodium; and

a step of moving part of sodium pre-doped in the negative-electrode active material to the positive-electrode active material in the positive electrode.

### (Appendix 2)

In the method for producing a molten-salt battery described in Appendix 1, sodium is moved to the positive-electrode active material in the positive electrode until the amount of Na relative to a total of metal elements other than Na becomes 90 to 110 atomic percent.

### (Appendix 3)

In the method for producing a molten-salt battery described in Appendix 2, when sodium is moved to the positive-electrode active material in the positive electrode until the amount of Na relative to the total of metal elements other than Na becomes 90 to 110 atomic percent, the negative-electrode active material in the negative electrode is doped with sodium in an amount equal to or more than an amount corresponding to an irreversible capacity of the negative-electrode active material.

### EXAMPLES

Next, the present invention will be more specifically described using Examples. However, the Examples described below do not limit the present invention.

### Example 1

### (Synthesis of Positive-Electrode Active Material)

Potassium hydroxide was added to a mixed aqueous solution containing iron sulfate and cobalt sulfate in a molar ratio of 1:1 to prepare a coprecipitated hydroxide containing iron and cobalt. The resulting coprecipitated hydroxide and Na₂O₂ were mixed in a predetermined mass ratio. The resulting mixture was fired at 900° C. in air for 12 hours. Thus, Na_{0.67}Fe_{0.5}Co_{0.5}O₂ was obtained.

### (Preparation of Positive Electrode)

First, 85 parts by mass of Na_{0.67}Fe_{0.5}Co_{0.5}O₂ (positive-electrode active material) having an average particle size of 5 μm, 10 parts by mass of acetylene black (conductive agent), and 5 parts by mass of PVdF (binder) were dispersed in N-methyl-2-pyrrolidone (NMP) to prepare a positive electrode paste. The resulting positive electrode paste was applied to a surface of an aluminum foil having a thickness of 20 μm, sufficiently dried, and rolled to prepare a positive electrode having a thickness of 80 μm. The positive electrode was punched into a coin shape with a diameter of 12 mm.

### (Preparation of Negative Electrode)

A metallic sodium disk (manufactured by Aldrich, thickness: 200 μm) was pressure-bonded to a nickel current collector to prepare a negative electrode having a total thickness of 700 μm. The negative electrode was punched into a coin shape with a diameter of 12 mm.

### (Separator)

A separator formed of a glass microfiber (manufactured by Whatman, grade GF/A, thickness: 260 μm) was prepared.

### (Molten-Salt Electrolyte)

A molten-salt electrolyte formed of a mixture of Na.FSA and Py13.FSA in a molar ratio (Na.FSA:Py13.FSA) of 40:60 was prepared.

### (Assembly of Molten-Salt Battery)

The coin-shaped positive electrode, negative electrode, and the separator were heated at 90° C. or more under a reduced pressure of 0.3 Pa and sufficiently dried. Subsequently, the coin-shaped negative electrode was placed in a shallow, cylindrical container formed of an Al/SUS cladding material. The coin-shaped positive electrode was placed thereon with the coin-shaped separator therebetween. A predetermined amount of the molten-salt electrolyte was charged into the container. Subsequently, an opening of the container was sealed with a shallow, cylindrical sealing plate formed of an Al/SUS cladding material and provided with an insulating gasket on the circumference thereof. Thus, a pressure was applied, between the bottom surface of the container and the sealing plate, to an electrode group including the negative electrode, the separator, and the positive electrode to ensure contact between the members. A coin-type battery A (half cell) having a designed capacity of 1.5 mAh was prepared in this manner.

### Comparative Example 1

A coin-type battery B was prepared as in Example 1 except that a propylene carbonate solution (NaPF₆/PC) containing NaPF₆ in a concentration of 1 mol/L was used as an electrolyte.

### [Evaluation 1]

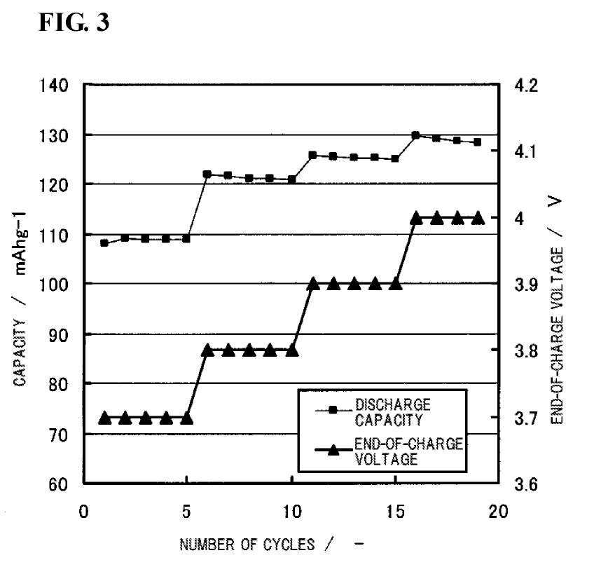

The coin-type batteries of Example 1 and Comparative Example 1 were heated to 40° C. in a thermostatic chamber. In a state where the temperature was stable, charging and discharging of the coin-type batteries of Example 1 and Comparative Example 1 were performed in which the conditions (1) and (2) described below were applied to one cycle while the upper limit voltage was changed every 5 cycles. FIG. 3 shows the relationship between the number of cycles and the upper limit voltage (end-of-charge voltage) and between the number of cycles and the discharge capacity of the battery of Example 1 at 40° C.

(1) Current density: 29.4 mA/g (current value corresponding to 0.2C), Charging is performed up to an upper limit voltage (end-of-charge voltage) of Vx (Vx=3.5 V, 3.6 V, . . . 4.4 V).

(2) Current density: 29.4 mA/g (current value corresponding to 0.2C), Discharging is performed down to a lower limit voltage (end-of-discharge voltage) of 2 V.

Table I shows an average coulombic efficiency of 5 cycles at 40° C. in each upper limit voltage of Example 1 and Comparative Example 1.

TABLE I

| | Upper limit voltage | | | | | | | | | |
|---|---|---|---|---|---|---|---|---|---|---|
| | 3.5 V | 3.6 V | 3.7 V | 3.8 V | 3.9 V | 4.0 V | 4.1 V | 4.2 V | 4.3 V | 4.4 V |
| Battery A | 100% | 100% | 100% | 100% | 100% | 99.8% | 98.5% | 96.1% | 97.2% | 98.8% |
| Battery B | 100% | 100% | 100% | 68.3% | 37.5% | 23.7% | 21.1% | 18.5% | 15.3% | 13.4% |

In order to achieve good cycle characteristics, the coulombic efficiency is preferably 99% or more. Referring to FIG. 3 and Table I, it is understood that, at 40° C., the battery of Example 1 is preferably charged and discharged at an upper limit voltage of 4.0 V or less. There is the same tendency at a temperature of less than 90° C.

### [Evaluation 2]

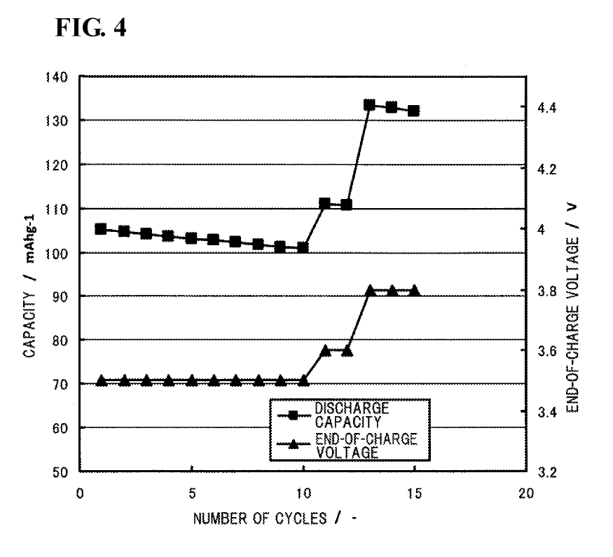

The coin-type battery of Example 1 was heated to 90° C. in a thermostatic chamber. In a state where the temperature was stable, charging and discharging of the coin-type battery of Example 1 were performed under the same conditions as those in Evaluation 1. FIG. 4 shows the relationship between the number of cycles and the upper limit voltage (end-of-charge voltage) and between the number of cycles and the discharge capacity of the battery of Example 1 at 90° C.

Note that since the battery of Comparative Example 1 included an organic electrolyte solution, charging and discharging at 90° C. could not be performed.

Table II shows an average coulombic efficiency of 5 cycles at 90° C. in each upper limit voltage of Example 1.

TABLE II

| | Upper limit voltage | | | | | | | | | |
|---|---|---|---|---|---|---|---|---|---|---|
| | 3.5 V | 3.6 V | 3.7 V | 3.8 V | 3.9 V | 4.0 V | 4.1 V | 4.2 V | 4.3 V | 4.4 V |
| Battery A | 99.5% | 99.4% | 99% | 98% | 97.6% | 97% | 96.5% | 96.1% | 95% | 95% |

Referring to FIG. 4 and Table II, at 90° C., it is understood that the battery of Example 1 is preferably charged and discharged at an upper limit voltage of 3.7 V or less. It is believed that there is the same tendency at a temperature of 90° C. or more and, for example, 120° C. or less.

It is also understood that the coulombic efficiency in Example 1 is higher than that in Comparative Example 1 when the charging is performed at an upper limit voltage of 3.8 V or more.

The batteries after the evaluations were disassembled. The concentrations of elements dissolved in the molten salt electrolyte and the organic electrolyte solution were analyzed by inductively coupled plasma (ICP) analysis. Table III shows the results.

TABLE III

| | |
|---|---|
| 40° C. | 90° C. |

| Element | Fe | Co | Fe | Co |
|---|---|---|---|---|
| Battery A | 0.10 ppm | >0.02 ppm | 0.22 ppm | >0.02 ppm |
| Battery B | 0.42 ppm | >0.02 ppm | — | — |

Table III shows that the amount of Fe dissolved in the organic electrolyte solution (NaPF₆/PC) is larger than that in the molten-salt electrolyte.

### Example 2

First, 96 parts by mass of hard carbon (negative-electrode active material) and 4 parts by mass of a polyamide-imide (binder) were dispersed in NMP to prepare a negative electrode paste. The resulting negative electrode paste was applied to a surface of an aluminum foil having a thickness of 20 μm, sufficiently dried, and rolled to prepare a negative electrode having a thickness of 75 μm. The negative electrode was punched into a coin shape with a diameter of 14 mm. The hard carbon had an average interplanar spacing d₀₀₂ of 0.38 nm, an average specific gravity of 1.5 g/cm³, and an average particle size of 10 μm.

A coin-type battery C was prepared as in Example 1 except that the above negative electrode was used. However, in the assembly of the battery, a foil was disposed between the positive electrode and the negative electrode, the foil containing metallic sodium in an amount corresponding to an irreversible capacity of the negative electrode, and metallic sodium in an amount that is required until the composition of the positive-electrode active material is changed from Na_{0.67}Fe_{0.5}Co0.5O₂ to NaFe_{0.5}Co_{0.5}O₂. Furthermore, the battery after the assembly was aged at 40° C. for 12 hours so that the negative electrode is sufficiently pre-doped with sodium. The battery C was then evaluated as in Evaluation 1 described above. Table IV shows the results.

TABLE IV

| | Upper limit voltage | | | | | | | | | |
|---|---|---|---|---|---|---|---|---|---|---|
| | 3.5 V | 3.6 V | 3.7 V | 3.8 V | 3.9 V | 4.0 V | 4.1 V | 4.2 V | 4.3 V | 4.4 V |
| Battery C | 100% | 100% | 100% | 100% | 100% | 98.3% | 97.9% | 96.0% | 96.2% | 95.9% |

Referring to the results in Table IV, it is found that, as in the battery A, the battery C also shows a stable cycle up to an upper limit voltage of 3.9 V.

The molten-salt battery according to the present invention has a high capacity and a good cycle life. Accordingly, the molten-salt battery is useful in applications in which long-term reliability is required, for example, in large-scale power storage apparatuses for household and industrial use and power sources for electric vehicles, hybrid vehicles, and the like.

1. A molten-salt battery comprising:
a positive electrode including a positive-electrode active material that reversibly occludes and releases sodium;
a negative electrode including a negative-electrode active material that reversibly occludes and releases sodium;
a separator disposed between the positive electrode and the negative electrode; and
a molten-salt electrolyte,
wherein the molten-salt electrolyte contains an ionic liquid in an amount of 90% by mass or more,
the ionic liquid contains a first salt and a second salt,
the first salt contains a sodium ion which is a first cation, and a first anion,
the second salt contains an organic cation which is a second cation, and a second anion,
the positive-electrode active material contains a composite oxide having a layered O3-type crystal structure and containing Na, Fe, and Co, and
an amount of Co relative to a total of Fe and Co contained in the composite oxide is 40 to 60 atomic percent.

2. The molten-salt battery according to claim 1, wherein the composite oxide is NaₓFe_{y}Co_{z}O₂ (where 0.6≦x≦1, 0.45≦y≦0.55, 0.45≦z≦0.55, and y+z=1).

3. The molten-salt battery according to claim 1, wherein the first anion and the second anion are each independently represented by a general formula: [(R¹SO₂)(R²SO₂)]N⁻ (where R¹ and R² are each independently F or CₙF₂ₙ₊₁ where 1≦n≦5).

4. The molten-salt battery according to claim 1, wherein the organic cation is at least one selected from the group consisting of a quaternary ammonium cation and an organic cation having a nitrogen-containing heterocycle.

5. The molten-salt battery according to claim 1, wherein the negative-electrode active material is at least one selected from the group consisting of hard carbon, a sodium-containing titanium oxide, and a lithium-containing titanium oxide.

6. A charge-discharge method for charging and discharging the molten-salt battery according to claim 1, the method comprising:
a step of sensing a temperature of the molten-salt battery;
a step of charging and discharging the molten-salt battery at an upper limit voltage that is a first voltage V1 when the sensed temperature of the molten-salt battery is a temperature equal to or less than a predetermined temperature T1 selected from a range of 60° C. to 90° C.; and
a step of charging and discharging the molten-salt battery at an upper limit voltage that is a second voltage V2 lower than the first voltage V1 when the sensed temperature of the molten-salt battery is a temperature exceeding the first temperature T1.

7. The charge-discharge method according to claim 6,
wherein the first voltage V1 is 3.9 to 4.2 V, and
the second voltage V2 is 3.8 V or less.

8. A charge-discharge system comprising:
the molten-salt battery according to claim 1;
a temperature measurement unit that senses a temperature of the molten-salt battery;
a charge control device that controls charging of the molten-salt battery; and
a discharge control device that controls discharging of the molten-salt battery,
wherein the charge control device sets an upper limit voltage of charging to be lower with an increase in the temperature of the molten-salt battery sensed by the temperature measurement unit.

9. The charge-discharge system according to claim 8, wherein the upper limit voltage is selected from at least two values of a set upper limit voltage Vk (k=1, 2, . . . ) such that the upper limit voltage decreases with an increase in the sensed temperature of the molten-salt battery.

10. The charge-discharge system according to claim 9,
wherein when the sensed temperature of the molten-salt battery is a temperature equal to or lower than a predetermined temperature T1 selected from a range of 60° C. to 90° C., a first voltage V1 of 3.9 to 4.2 V is selected as the set upper limit voltage Vk, and
when the sensed temperature of the molten-salt battery is a temperature exceeding the temperature T1, a second voltage V2 of 3.8 V or less is selected as the set upper limit voltage Vk.
